(19) United States
(12) Patent Application Publication
(10) Pub. No.: US 2008/0106482 A1
(43) Pub. Date: May 8, 2008

(54) Electronically scanned hemispheric antenna

(76) Inventors: Alan Cherrette, Hermosa Beach, CA (US); Carl Wise, Severna Park, MD (US); Arun Bhattacharyya, El Segundo, CA (US); Michael Wrobleski, Los Angeles, CA (US); Allan Goetz, La Jolla, CA (US)

Correspondence Address: PATTI, HEWITT & AREZINA LLC, ONE NORTH LASALLE STREET, 44TH FLOOR, CHICAGO, IL, 60602, US

(21) Appl. No.: 11/594,320

(22) Filed: Nov. 8, 2006

(51) Int. Cl. H01Q 21/00; H01Q 1/42

(52) U.S. Cl. 343/872; 343/893

(57) ABSTRACT

A low-profile, electronically scanned antenna that can scan a hemisphere is comprised of three, phased array radiators. Each radiator face has an azimuth and elevation scan angle equal to 120 degrees. The three radiator faces are arranged in a truncated 3 sided pyramid such that they prove continuous hemispherical coverage. The three radiators are mounted to cooled panels of a truncated pyramid-shaped frame such that the radiators enable a full hemisphere to be scanned by radar.

### STATEMENT OF GOVERNMENT RIGHTS

The Government of the United States of America has rights in this invention pursuant to Contract No. F19620-00-C-0002 awarded by the United States Air Force.

### TECHNICAL FIELD

The invention relates generally to radar and communications antennas and more particularly to a phased array antenna for use with aircraft.

### BACKGROUND

There is growing commercial as well as military need for wideband radar and communications on aircraft, ships and ground-based craft. In many of these applications, low-height antennae are needed that can provide spherical or hemispherical coverage.

Low-cost electronically scanned antennas exist but these prior art antennas are planar and have scan angles limited to approximately ±60 degrees. At 60 degrees, the performance of these antennas is very poor.

As is known, antennas used on aircraft, ships and vehicles require radomes to protect radiating elements from wind and water. Radomes strong enough to withstand weather and bird strikes typically have thick walls, which reduce their RF transmissivity and hence their electrical performance but increasing their cost and weight. A simple and inexpensive antenna that provided hemispherical or spherical coverage without requiring a lossy and expensive radome, and which could be on aircraft, ships and terrestrial vehicles would be an improvement over the prior art.

### SUMMARY

There is provided an antenna for mounting on the exterior surface of an aircraft, ship or other vehicle, which is comprised of three phased array radiators. The arrays are mounted to a frame such that the radiators and the frame are in the shape of a truncated pyramid.

Each radiator has a center axis that is normal to the radiator. Each radiator has a radar scan angle substantially equal to ±60 degrees relative to the center axis. The radiators are mounted to a frame such that the angle between adjacent center axes forms an angle of 120 degrees.

Since each radiator has a scan angle substantially equal to ±60 degrees relative to each radiator's center axis, and since the radiators are positioned on the circumference of a geometric circle, three of the radiators can sweep an azimuth angle of 360 degrees and an elevation angle of ±60 degrees =120 degrees. A full hemisphere can be swept by the three antennas.

Because of their truncated pyramid shape, their mounting arrange provides a robust, wind-resistant structure with flush mounted radomes protecting each of the three radiating surfaces. A hemispherical radome is not needed.

### BRIEF DESCRIPTION OF THE DRAWINGS

FIG. 1 is a top view of an electronically scanned hemispheric antenna;

FIG. 2 is a side view of the antenna shown in FIG. 1;

FIG. 3 is a cross-sectional view of one of the panels or sides of the antenna shown in FIG. 1 and FIG. 2;

FIG. 4 illustrates an application for the antenna, namely its attachment and use with an airplane; and

FIG. 5 shows an exploded view of the antenna depicted in each of FIGS. 1-4.

### DETAILED DESCRIPTION

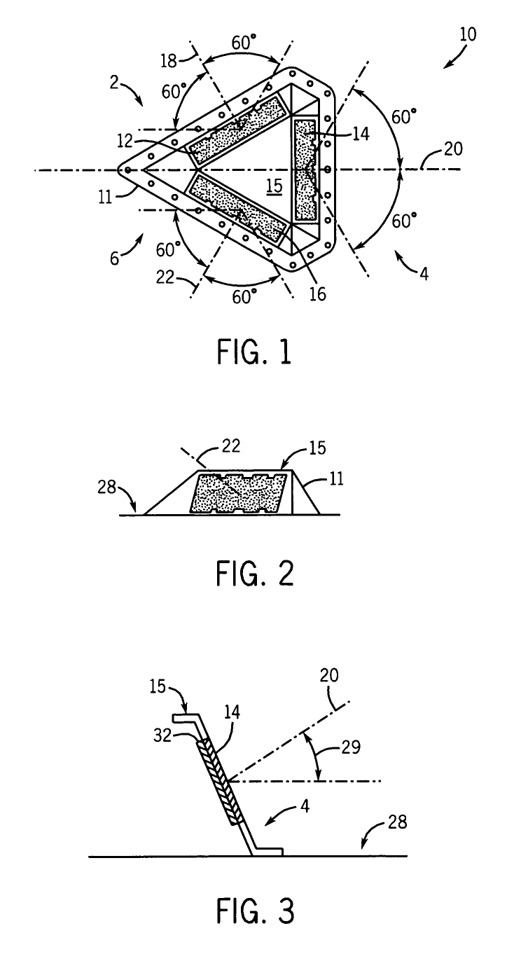

FIG. 1 shows a top view of an electronically scanned hemispheric antenna 10 and FIG. 2 shows a side view of the antenna 10. As can be seen in FIGS. 1 and 2, the antenna 10 is comprised of an airfoil or fairing 11 in the shape of a truncated pyramid in that it has three inclined sides 2, 4 and 6 joined to each other but also joined to a flat top 15. The three sides 2, 4 and 6 also rest on a flat surface 28, such as a surface of an airplane, helicopter or terrestrial vehicle.

The three inclined sides 2, 4 and 6 of the fairing 11 accommodate three, inclined phased array radiators 12, 14 and 16. Each of the radiators 12, 14 and 16 is substantially planar and has a geometric center axis that is normal or substantially normal to a geometric plane in which the corresponding radiator lies. The axes of the radiators 12, 14 and 16 are identified in the figures by reference numerals 18, 20 and 22 respectively. Since each center axis 18, 20 and 22 is normal to its corresponding radiator (12, 14 and 16 respectively), each center axis forms a geometric angle with adjacent axes such that the projected angle, on plane 28, between any two adjacent axes is one-hundred twenty degrees (120 degrees).

The three radiators 12, 14 and 16 and the sides 2, 4 and 6 they are attached to, abut each other such that they enclose a substantially triangular-shaped area, readily seen in FIG. 1. As is well-known, the sum of the interior angles of a triangle equals 180 degrees. Therefore, the sum of the angles formed between the radiators 12, 14 and 16 is equal to 180 degrees.

FIG. 3 depicts the cross section of one of the phased array radiators 14 as it lies in one of the sides 4. (The cross sections of the other phased array radiators are identical to the cross section depicted in FIG. 2.) As can be see in FIG. 3, the phased array radiators are inclined relative to the antenna's flat top 15 and relative to the surface 28 by an elevation angle 29. Since the flat top 15 and the surface 28 are depicted in FIG. 3 as being parallel to each other, the angle between the axes 18, 20 or 22 and the top surface 15 or the “bottom” surface 28 is the same.

Each radiator 12, 14 and 16 is a phased array radiator, the operation of which is well-known to those of ordinary skill in radar. Each radiator 12, 14 and 16 has a radar azimuth and elevation scan angle that is substantially equal to ±60 degrees relative to each radiator's center axis 18, 20 and 22 such that each radiator 12, 14 and 16 is capable of scanning an azimuth and elevation angle of up to one hundred twenty degrees (120 degrees).

Since there are three phased array radiators 12, 14 and 16 that each sweep a different 120 degree azimuth angle, and since each radiator 12, 14 and 16 can sweep an elevation angle of ±60 degrees from its respective center axis 18, 20, 22, the three phased array radiators 12, 14 and 16 enable the antenna to electronically scan a full, or substantially full, hemisphere.

Referring to FIG. 1 and FIG. 5, the radiators 12, 14 and 16 are mounted to a pyramidal-shaped frame 31 (shown in FIG. 5 but not in FIG. 1) such that the lower apexes of each of the radiators 12, 14 and 16 lie on the circumference of a geometric circle that is centered about the geometric triangle enclosed by the sides 2, 4 and 6 and/or the radiators 12, 14 and 16. For purposes of this disclosure, the radiators are therefore considered to lie “on” the circumference of a circle, however, only the apexes or corners of the radiator's are actually on a geometric circle.

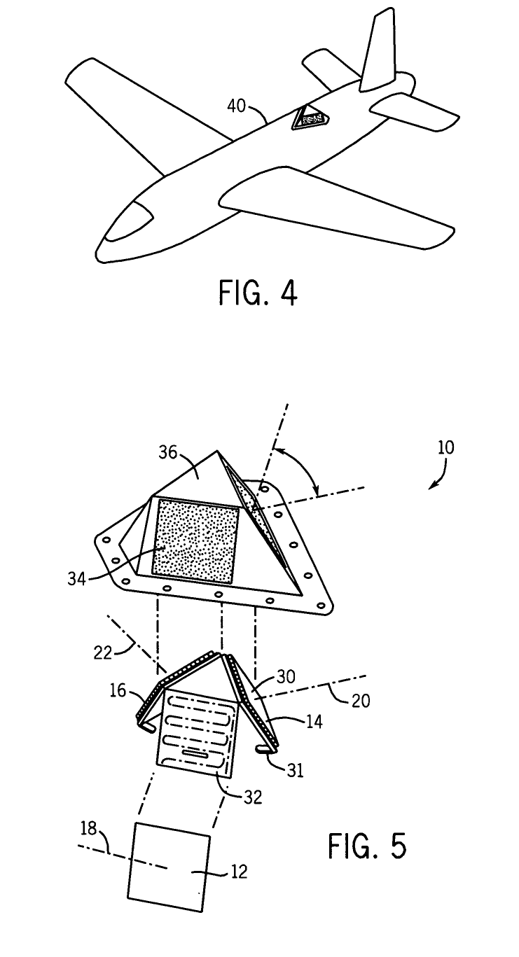

Referring now to FIG. 4 there is shown an airplane 40 with one of the antennas 10 shown as being mounted on top of the fuselage of the airplane 40. A second antenna 10 mounted on the underside or bottom of the fuselage (not shown) can provide the ability to scan a second hemisphere, except for the small space between the antenna on top of the fuselage and the antenna on the bottom of the fuselage.

While the embodiment shown in FIG. 4 depicts the antenna 10 mounted on the fuselage, alternate embodiments of the invention disclosed and claimed herein include mounting one or more of the antennas on an upper and/or lower wing surface by which a full hemispherically-shaped volume could be scanned by the arrays 12, 14 and 16 in the respective antennas. After viewing FIG. 4, those of ordinary skill in the art will recognize that one or more of the antennas 10 could also be mounted on a helicopter, ship or a terrestrial vehicle to provide a hemispheric radar or communications antenna to helicopters, ships or terrestrial vehicles.

Referring now to FIG. 5 there is shown an exploded view of the antenna 10. The planar arrays 12, 14 and 16, which can also be considered as electromagnetic signal radiating elements, are mounted to a frame 31 in the shape of a truncated pyramid in that the frame 31 has three planar sides 30, 32, and 34 that are inclined relative to flat, top and bottom surfaces.

Each of the sides 30, 32 and 34 can include an integrated cooling channel or panel 42 to cool the arrays 12, 14 and 16 if the power level emitted from the arrays 12, 14 and 16 is so great that it heats or overheats the frame 31, the fairing material or the material from which the arrays are constructed. In one embodiment, a cooling fluid (not shown) circulates through the channels 42 to remove heat from the planar arrays 12, 14 and 16 that are mounted against the sides 30, 32 and 34 to be in thermal contact with the sides. Heat from the arrays 12, 14 and 16 travels from the arrays into the planar sides and then into the coolant by conduction, such that the coolant ultimately absorbs thermal energy emitted from the radiating elements 12, 14 and 16.

The coolant circulated through the channels 42 could include any appropriate refrigerant gas or liquid. In an alternate embodiment, a ventilated or unventilated heat sink is used with one or more such heat sinks being in thermal communication with its corresponding radiator element 12, 14 and 16.

Not shown in the figures are substantially planar radar-transmissive radomes that cover or “extend over” the radiating surfaces 12, 14 and 16. Radar-transmissive radomes and the materials they are usually constructed from are well known to those of ordinary skill in the art. Radomes extending over the arrays are useful to protect the radiators 12, 14 and 16 from damage that can be caused by impacts with precipitate, animals as well as damage that can be caused by impacts with small objects. The radomes used in one embodiment were substantially flush with the surface of the fairing that covers the radiator elements 12, 14 and 16.

Those of ordinary skill in the art will appreciate the cost effectiveness of using multiple phased array elements 12, 14 and 16 that are capable of beam steering or directing a radar or communications beam up to 120 degrees. Those of ordinary skill in the art will also recognize the value of not using a rotating radome as the prior art teaches but instead using a low-cost and low-profile, fixed, i.e., non-rotating radome with emitted signals being electronically steered. The truncated pyramidal-shaped antenna 10 depicted in the drawings provides superior beam scan angles in a low-profile antenna that is more rugged than prior art rotating radomes and less expensive to manufacture.

It should be borne in mind that the description above is purposes of illustration only and not for purposes of limitation. The true scope of the invention is defined by the appurtenant claims.

What is claimed is:

1. An antenna comprising:
first, second and third phased array radiators (hereafter “radiators”), each of said radiators having an axis that is normal to the radiator, each radiator having a scan angle substantially equal to ±60 degrees relative to each radiator's center axis, the radiators being positioned on the circumference of a geometric circle.

2. The antenna of claim 1 wherein the geometric circle lies in a substantially horizontal plane.

3. The antenna of claim 1 wherein the first, second and third phased array radiators are substantially planar.

4. The antenna of claim 2 wherein the center axes of the first, second and third phased array radiators are upwardly inclined with respect to the horizontal plane.

5. The antenna of claim 1 wherein the first, second and third phased array radiators have vertical and azimuth scan angles that are both substantially equal to ±60 degrees relative to the radiator's axis so that radar signals from the three radiators can be controlled to be swept over a hemisphere.

6. The antenna of claim 1 wherein the first, second and third planar phased array radiators enclose a substantially triangular shape.

7. The antenna of claim 1 wherein the first, second and third planar phased array radiators enclose a truncated pyramid.

8. The antenna of claim 1 wherein the first, second and third planar phased array radiators abut each other such that the sum of the angles they enclose equal 180 degrees.

9. The antenna of claim 1 wherein each radiator is comprised of:
electromagnetic signal radiating elements; and
a coolant that absorbs thermal energy emitted from the electromagnetic signal radiating elements.

10. An antenna comprising:
first, second and third phased array planar radiators (hereafter “radiators”), each of said planar radiators having a center axis that is normal to the radiator, each radiator having an azimuth scan angle substantially equal to ±60 degrees relative to each radiator's center axis, and each radiator has a vertical scan angle substantially equal to ±60 degrees relative to each radiator's center axis, the radiators being positioned on the circumference of a geometric circle.

11. The antenna of claim 9 wherein the geometric circle lies in a substantially horizontal plane.

12. The antenna of claim 10 wherein the center axes of the first, second and third phased array radiators are upwardly inclined with respect to the horizontal plane, at the same angle.

13. The antenna of claim 9 wherein the first, second an third planar phased array radiators enclose a volume that is substantially in the shape of a truncated pyramid.

14. The antenna of claim 9 wherein the first, second an third planar phased array radiators abut each other such that the sum of the angles they enclose equal 180 degrees.

15. The antenna of claim 9 wherein each radiator is comprised of:
electromagnetic signal radiating elements; and
a coolant that absorbs thermal energy emitted from the electromagnetic signal radiating elements.

16. An antenna comprising:
first, second and third planar arrays, each of said planar arrays being substantially planar and having a geometric center axis that extends substantially perpendicular from the geometric center of a radiating face of each radiator, each radiator having vertical and azimuth scan angles that are both substantially equal to ±60 degrees relative to each radiator's center axis, the planar arrays being positioned on the circumference of a geometric circle; and
first, second and third, radar-signal transmissive radomes extending over the radiating faces of the first, second and third planar arrays respectively such that the planar arrays are behind the radomes and the radomes are mechanically supported by the planar arrays.

17. The antenna of claim 16 wherein the geometric circle lies in a substantially horizontal plane.

18. The antenna of claim 16 wherein the first, second and third planar arrays are substantially planar and the radomes substantially conform to the planar arrays.

19. The antenna of claim 16 wherein the center axes of the first, second and third planar arrays are upwardly inclined with respect to the horizontal plane, at substantially the same angle.

20. The antenna of claim 16 wherein the first, second and third planar arrays emit electromagnetic signals from each radiator that can be swept over a hemisphere.

21. The antenna of claim 16 wherein the first, second an third planar planar arrays abut each other such that the first, second and third planar arrays enclose a substantially triangular shape.

22. The antenna of claim 16 wherein each radiator is comprised of:
electromagnetic signal radiating elements; and
a coolant that absorbs thermal energy emitted from the electromagnetic signal radiating elements.

23. An antenna comprising:
first, second and third phased array radiators (hereafter “radiators”), each of said radiators being substantially planar and having a electromagnetic signal radiating face having geometric center axis that extends perpendicularly from the geometric center of the radiating face of each radiator, each radiator having a vertical and azimuth scan angle substantially equal to ±60 degrees relative to each radiator's center axis;
first, second and third, radar-signal transmissive radomes that conform to and which extend over the radiating faces of the first, second and third radiators respectively such that the radiators are behind the radomes, the radomes being mechanically supported by the radiators; and
a three-sided, truncated-pyramidal-shaped fairing having first, second and third inclined faces that receive the first, second and third radomes.

24. The antenna of claim 23 wherein the sides of the truncated-pyramidal-shaped fairing are inclined at a first predetermined angle.

25. The antenna of claim 24 wherein the first, second and third phased array radiators are substantially planar and the radomes conform to the radiators.

26. The antenna of claim 23 wherein the center axes of the first, second and third phased array radiators are upwardly inclined with respect to the horizontal plane, at the same angle.

27. The antenna of claim 23 wherein the first, second and third phased array radiators are capable of emitting electromagnetic signals from each radiator that can be swept over a hemisphere.

28. The antenna of claim 23 wherein each radiator is comprised of:
electromagnetic signal radiating elements; and
a coolant that absorbs thermal energy emitted from the electromagnetic signal radiating elements.
